(19) United States
(12) Patent Application Publication
(10) Pub. No.: US 2024/0287853 A1
(43) Pub. Date: Aug. 29, 2024

(54) Profile for connecting a blind to a roller tube, transport kit of such profile and system for anchoring a blind to a support wall

(71) Applicant: Plastex SA, Madonna del Piano (CH)

(72) Inventor: Marco Lombardini, Vernate (CH)

(21) Appl. No.: 18/571,179

(22) PCT Filed: Jun. 27, 2022
(86) PCT No.: PCT/IB2022/055933

§ 371 Date: Dec. 15, 2023

(30) Foreign Application Priority Data
Jun. 25, 2021 (IT) 102021000016799
Jun. 25, 2021 (IT) 102021000016805

(51) Int. Cl. E06B 9/44

(52) U.S. Cl. CPC E06B 9/44

(57) ABSTRACT

A profile usable in a roller blind system to connect a blind to a roller tube and/or a fastening bar, one or both of which have a longitudinal channel defining a first axis, has an elongated shape that defines a second longitudinal axis. The profile includes a first longitudinal portion for the connection to an end of the blind and a second shaped longitudinal portion designed to be removably inserted into the longitudinal channel so that the first and the second axis are parallel to, or coincident with, one another.

### FIELD OF THE INVENTION

The present invention generally relates to the technical field of systems for anchoring a roller blind to a wall, and it particularly relates to a profile for connecting the blind to a roller tube. The invention also relates to a kit for transporting the connection profile and a system comprising such profile.

### STATE OF THE ART

Systems for anchoring roller blinds to load-bearing structures such as walls or trusses are known. Such systems comprise a roller tube to which the blind is to be fixed.

Generally, the roller tube comprises a longitudinal channel, while an end of the blind is glued or welded to a connection profile designed to be inserted into the longitudinal channel.

The known profiles are made of rigid material, typically made of metal, and they have various shapes and sizes depending on the size of the roller tube and therefore of the longitudinal channel.

Such devices can be improved in various ways.

A first disadvantage of such connection profiles is to require a specific profile for each channel resulting in an evident increase of production times and costs besides a complication for the installation technician who must identify the correct connection profile.

A further disadvantage of the known connection profiles lies in the fact that it has high longitudinal overall dimensions, therefore making transportation and transfer operations complex and expensive.

### SUMMARY OF THE INVENTION

An object of the present invention is to at least partly overcome the aforementioned drawbacks, by providing a connection profile that is highly functional and cost-effective.

Another object of the present invention is to provide a system for installing a blind to a wall that is highly functional and cost-effective.

These and other objects that will be more apparent hereinafter, are attained by a system for anchoring a blind to a wall and by a connection profile as described and/or claimed and/or illustrated herein.

Advantageous embodiments of the invention are defined according to the dependent claims.

A longitudinal profile which can be used in a roller blind system for mutually connecting a blind and a roller tube and/or a fastening bar, may be provided for. The one and/or the other of the latter comprising a longitudinal channel defining a first axis. The profile may have an elongated shape to define a second longitudinal axis. The profile may further comprise at least one first longitudinal portion for mutual connection with an end of the blind and at least one second longitudinal portion designed to be inserted into the longitudinal channel so that the first and second axis are mutually parallel or coincident. The profile, may further comprise a third portion interposed between the first and the second portion interposed between the first and the second portion for mutual connection thereof. The third portion may be made of a first elastomeric material so as to allow the configuration variation of the profile between a working configuration extended along the second axis and a collapsed transportation configuration having longitudinal overall dimensions much smaller than the ones it has in the extended working configuration.

Advantageously, the profile in the collapsed transportation configuration may have longitudinal overall dimensions much smaller than the ones it has in the working configuration so that it is easy to transport.

Possibly, according to a particular embodiment, the profile mentioned above may have the first and the second portion made of a second and a third elastomeric material. The latter materials and the former elastomeric material may be the same elastomeric material.

Advantageously, in such case the profile may be particularly simple to obtain.

On the other hand, according to a different embodiment, the profile may have the second portion which includes or consists of a plurality of V-shaped or U-shaped elements made of a fourth material having greater rigidity with respect to the first elastomeric material. In particular, the plurality of elements may be interspaced by an interspace with predetermined length so as to allow the configuration variation of the profile between the extended working configuration and the collapsed transportation configuration.

Advantageously, the V-shaped or U-shaped elements made of the material having greater rigidity may guarantee a high sealing.

Irrespective of the above, a longitudinal profile which can be used in a roller blind system for mutually connecting a blind and a roller tube and/or a fastening bar, may be provided for. The one and/or the other of the latter comprising a longitudinal channel defining a first axis. The profile may have an elongated shape to define a second longitudinal axis. The profile may further comprise at least one first longitudinal portion for mutual connection with an end of the blind and at least one second longitudinal portion designed to be inserted into the longitudinal channel so that the first and second axis are mutually parallel or coincident. The longitudinal channel may have an inner surface with a pair of end edges arranged on opposite sides with respect to a median plane passing through the first axis. The end edges may have a first predetermined distance. The second portion may have a first and second opposite ends. Once the second portion is inserted into the longitudinal channel the first and second ends may be arranged on opposite sides with respect to the median plane and it may have a second mutual distance substantially greater than the first distance. The first end may have a first operative surface designed to come into contact with the inner surface of the longitudinal channel at one of the first and the second edge, the second opposite end including a second operative surface designed to come into contact with the inner surface of the channel at the other of the first and the second edge so as to avoid the disinsertion of the second portion of then channel. The second portion may be potentially inserted into the channel through radial transaction along a direction substantially parallel to or lying on the median plane. At least one portion of the second portion may be elastically deformable so that the profile is movable between a narrowed configuration in which the first and second end have the second distance equal to or smaller than the first distance so as to allow the insertion of the second portion in the channel and an expanded configuration in which the first and second end have the second distance substantially greater than the first distance so as to avoid the disinsertion of the second portion from the channel during use. The second portion may comprise an internal chamber for a working fluid and the second portion may be deformable between a narrowed configuration in which the volume of the internal chamber is minimum and the first and second end are in mutually proximal configuration, and an expanded configuration in which the volume of the internal chamber is maximum and the first and second end are in mutually distal configuration. The internal chamber may have at least one opening for the inflow/outflow of the working fluid into the/from the internal chamber so as to allow the passage of the internal chamber between the maximum volume and the minimum volume configuration. Means for the selective closing of at least one opening actuatable by an operator so as to selectively lock the internal chamber in expanded configuration once the second portion is inserted into the channel, may also be provided for.

Advantageously, in this manner the insertion/disinsertion of the portion into/from the channel may be particularly simple and quick.

Irrespective of the above, a longitudinal profile which can be used in a roller blind system for mutually connecting a blind and a roller tube and/or a fastening bar, may be provided for. The one and/or the other of the latter comprising a longitudinal channel defining a first axis. The profile may have an elongated shape to define a second longitudinal axis. The profile may further comprise at least one first longitudinal portion for mutual connection with an end of the blind and at least one second longitudinal portion designed to be inserted into the longitudinal channel so that the first and second axis are mutually parallel or coincident. The second portion may have a substantially concave coupling area. The first portion may include a substantially planar element with an end area coupled with the coupling area. The end area may be deformable so as to allow the passage of the substantially planar element between an inoperative configuration in which it extends in a plane substantially perpendicular to the coupling area so that once the second portion is inserted into the channel, the planar element extends radially to the roller, and a working configuration in which it extends in a plane substantially parallel to the coupling so that once the second portion is inserted into the channel, the planar element extends tangentially to the roller so as to allow the winding of the blind.

In this manner, operations for coupling the blind with the respective coupling portion of the profile could be particularly facilitated. Furthermore, advantageously, the blind may be coupled in both directions of rotation with respect to the roller.

### BRIEF DESCRIPTION OF THE DRAWINGS

Further characteristics and advantages of the invention will be more apparent in light of the detailed description some preferred but non-exclusive embodiments of the invention, illustrated by way of non-limiting example with reference to the attached drawings, wherein:

FIGS. 1 and 2 are a schematic view of a system 100 for installing a blind T to a wall P by using a roller tube 110 and a fastening bar 180 in different operating conditions;

FIG. 3 is an exploded schematic view of an embodiment of a connection profile 1 and of a channel 120;

FIGS. 4A, 4B, 4C and 4D are axonometric schematic views of some details of different embodiments of the connection profile 1;

FIGS. 5A, 5B, 5C and 5D are schematic views of some operating steps of a method for the insertion/disinsertion of at least one portion 20 of an embodiment of the connection profile 1 with the channel 120;

FIGS. 6A, 6B, 6C and 6D are schematic views of some operating steps of a method for the insertion/disinsertion of at least one portion 20 of a further embodiment of the connection profile 1 with the channel 120;

FIGS. 7A and 7B are schematic views of a different embodiment of the connection profile 1 respectively inserted into and disinserted from the channel 120;

FIGS. 8A and 8B are schematic views of some operating steps of a method for the insertion/disinsertion of at least one portion 20 of another embodiment of the connection profile 1 with the channel 120;

FIGS. 9A and 9B are schematic views of some operating steps of a method for the insertion/disinsertion of at least one portion 20 of a further embodiment of the connection profile 1 with the channel 120;

FIGS. 10A, 10B and 10C are schematic views of some operating steps of a method for fixing a connection profile 1 with the roller tube 110;

FIGS. 11 and 12 are a schematic view of a particular embodiment of the connection profile 1 respectively in extended and collapsed configuration;

FIG. 13 is a schematic view of a container 150 comprising the connection profile 1 in a collapsed configuration;

FIGS. 14A, 14B, 14C, 14D and 5E are schematic views of a method for fixing the blind T and of a profile 1.

### DETAILED DESCRIPTION OF SOME PREFERRED EMBODIMENTS

With reference to the mentioned figures, herein described is a system 100 for installing a blind T at a support structure S such as a wall, a beam or the like.

Essentially, the system 100 may comprise at least one roller tube 110 for rolling the blind T. In greater detail, the blind T may have an end T1 which may be fixed to the roller tube 110 by means of a connection profile 1.

In particular, the roller tube 110 may have a longitudinal extension defining an axis Y′ and it may have a longitudinal channel 120 which may preferably have an extension over the entire length of the roller 110 along an axis Y substantially parallel to the axis Y′.

The channel 120 may have an inner surface 121 with a pair of longitudinal end edges 122, 123 arranged at the opposite side with respect to a median plane n passes through the axis Y. Preferably, but not exclusively, the channel 120 may be symmetrical with respect to such median plane n.

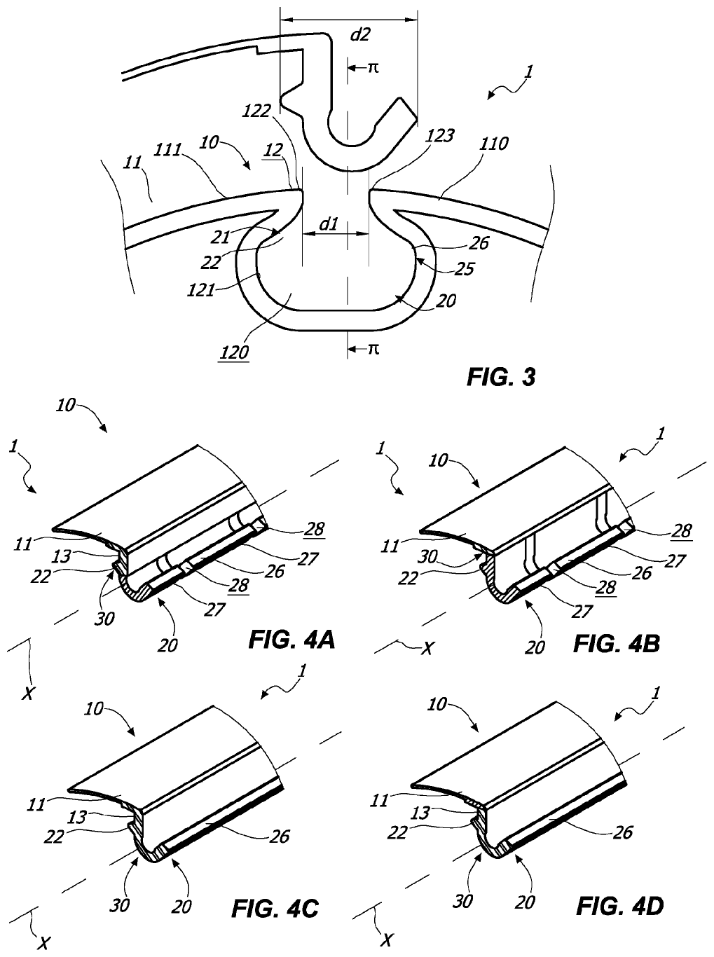

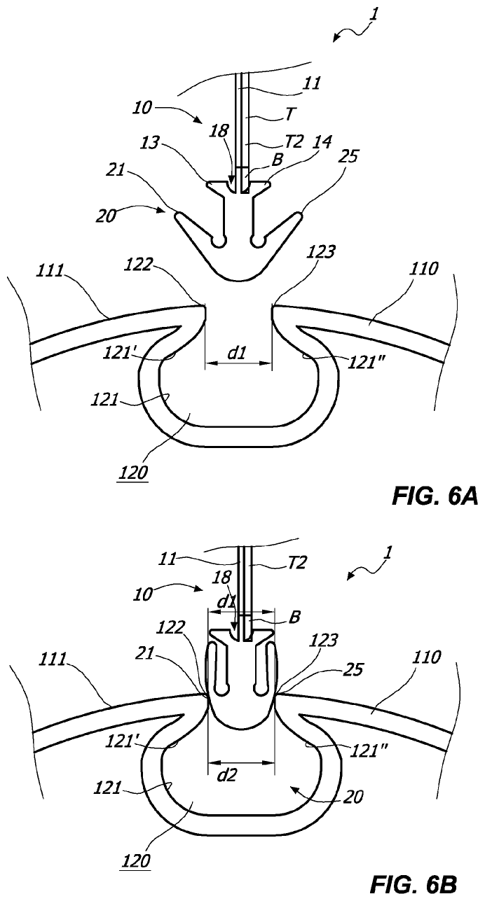

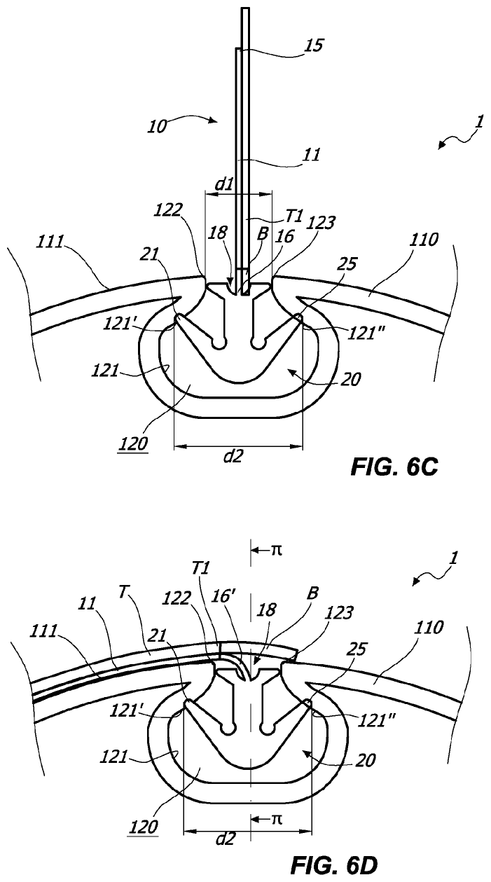

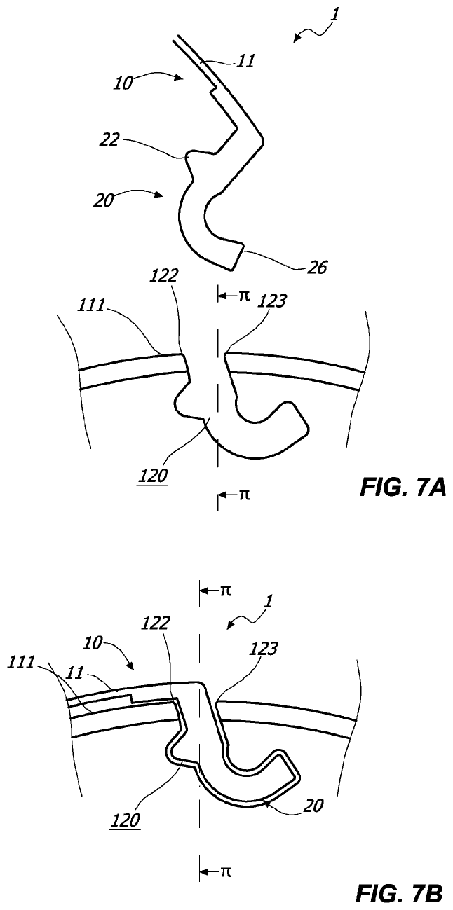

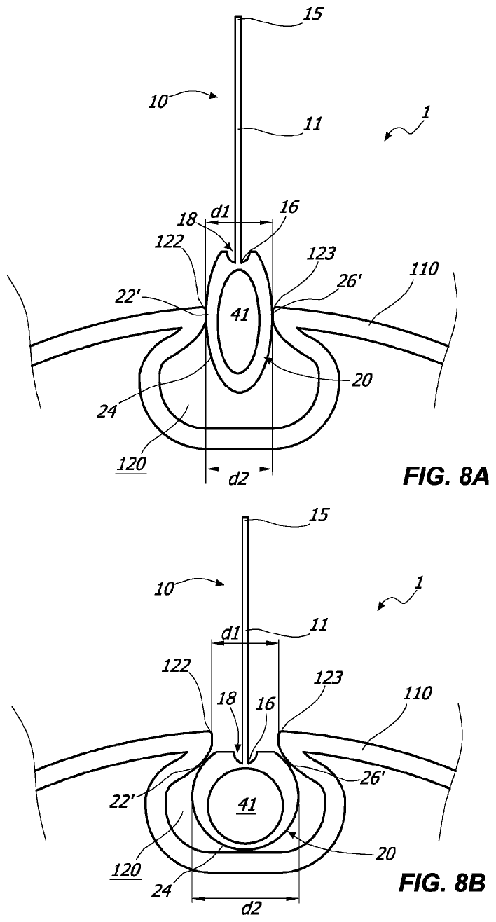

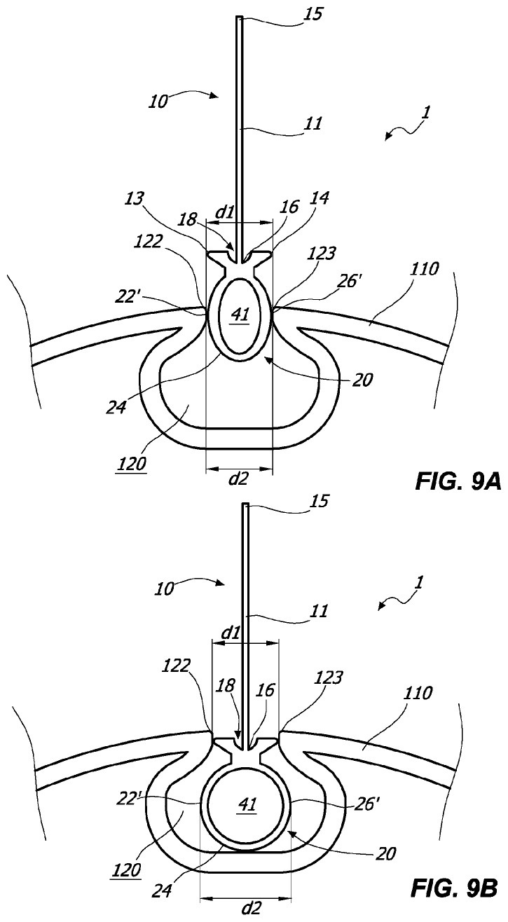

In particular, the channel 120 may have a generally U-shaped cross-section, for example as shown in FIG. 3, FIG. 6A, FIG. 8A and FIG. 9A, or it may be shaped differently as shown in a non-exclusive manner in FIG. 7A.

The connection profile 1, or simply profile hereinafter, may therefore have at least one portion 10 which may support the blind T and at least one portion 20 which may be fixed to the roller tube 110.

Generally, the portion 20 may be inserted into the channel 120 in a substantially axial manner, that is for sliding along the axis Y, or radially, that is for sliding perpendicularly to the axis Y.

Suitably, as better explained hereinafter, preferably the insertion may be carried out in a substantially radially so as to simplify the fixing operations and in general anchoring the blind T to the roller 110.

The portion 10 may preferably be configured to allow the fixing of the end T1 of the blind T. For example, the portion 10 may comprise or consist of a substantially planar element 11, for example a sail, while the end T1 of the sail T may be fixed to the element 11 by gluing, welding and other per se known manners.

When the profile 1 is in inoperative configuration, the sail 11 may be substantially radial, that is it may extend in a plane lying on or substantially parallel to the median plane n (FIG. 6A, FIG. 8A, FIG. 9A) or it may be substantially tangential (FIG. 3), that is it may extend in a plane substantially perpendicular to the median plane n and/or in a plane defined by the outer surface 111 of the roller 110.

Suitably, the sail 11 may comprise a vacant end 15 and an opposite end 16 coupled or made as a single piece with the portion 20. Advantageously, the sail 11 may comprise an area 16′ deformable at the end 16. In this manner, the sail 11 may be radially inserted into the channel (for example as shown in FIG. 6C). When winding the roller 110, the sail 11 may be folded with respect to the end 16 so that the sail 11 takes a substantially tangential configuration that is so that the sail adheres to the outer surface 111 of the roller 110.

In this manner, advantageously, the sail 11 may be folded indistinctively in one direction or in the opposite direction with respect to the roller 110. Furthermore, the same profile 1 may be “ambidextrous”. Due to these characteristics, the assembly operations can be particularly simple.

For example, FIG. 6C shows a sail 11 with the blind T in which the portion 20 is inserted into the channel 120 and the blind T is fixed to the sail 11 and the latter is in radial configuration, while FIG. 6D shows the sail 11 with the area 16′ folded so that the sail 11 at least partially adheres to the outer surface 111 of the roller tube 110. It is clear that such action may occur thanks to the winding action and/or to the weight of the blind T depending on the position of the roller tube 110.

It is clear that such aspect described above with reference to the sail 11 may be implemented in any profile 1.

Suitably, irrespective of the configuration of the portion 20, the profile 1 may comprise a concave area 18 at the end 16 of the sail 11 so as to facilitate the deformation of the area 16′ and therefore the folding of the sail 11.

Advantageously, such area 18 for coupling the sail 11 with the portion 20, once the latter is inserted into the channel 120, may remain substantially internal, that is inside the circumference defined by the outer surface 111 of the roller 110. For example, it may remain internal by about 5-7 mm.

In this manner, as schematically shown in FIG. 6D, an interspace for housing the folded curved area 16′ may be formed while the remainder of the sail 11 may adhere to the outer surface 111 of the roller 110.

This characteristic may allow to avoid the formation of folds or bumps upon the rotation of the blind T.

According to another aspect, as schematically shown in FIG. 6C and FIG. 6D, the blind T may be fixed to the portion 10 so that it remains a vacant end edge B. In this manner, advantageously, once the sail 11 has been folded, the vacant edge B may be moved away from the sail 11 (FIG. 6D). Thanks to this characteristic, when winding the blind T, the sail 11 may cover the space between the end 16 and the edge 122, while the vacant edge B may cover the space between the end 16 and the opposite edge 123.

Advantageously, there may therefore be avoided folds when winding/unwinding given that the edge B may cooperate with the outer surface 111 of the roller 110 to define a single substantially continuous circular surface and without depressions.

It is clear that the end T1 of the blind T may be fixed to the portion 10 in any manner without departing from the scope of protection of the attached claims.

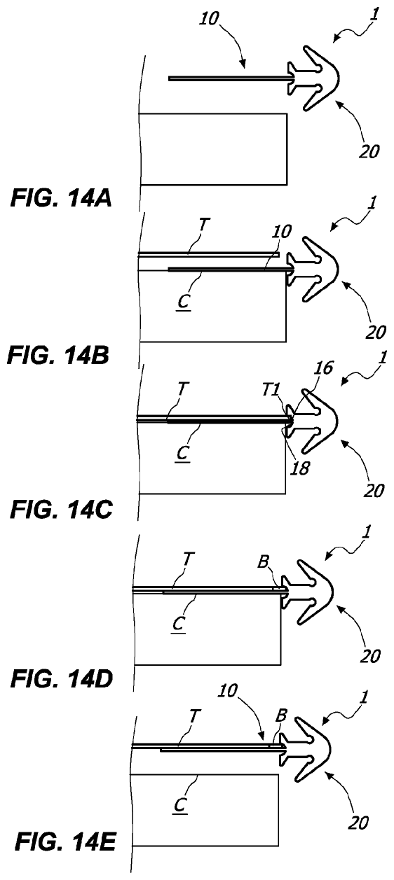

Advantageously, the sail 11 in radial position may facilitate the fixing of the blind T thereto. As a matter of fact, the profile 1 may be positioned longitudinally on a substantially horizontal work plane C (FIG. 14A) and the blind T may be positioned with preferred length so that the end T1 is at the portion 10 of the profile 1 (FIG. 14B). Suitably, the work plane C may support the blind T too.

In particular, the blind T may be positioned so that the end portion T1 thereof abuts against the concave area 18, that is at or in proximity of the end 16 of the sail 11 (FIG. 14C).

Subsequently, the blind T may be fixed to the sail 11 so that it remains a vacant edge B in proximity of the end 16 (FIG. 14D).

The profile 1 with the blind T may therefore be removed from the work plane C and it may be installed on a roller 110. Suitably, such operations described above may be carried out irrespective of the length of the blind T and/or of the profile 1 along the axis X. Therefore, both the blind T and the profile 1 may actually be easily cut to size.

In any case, irrespective of the description outlined above, the portion 20 may be inserted into the channel 120 so that the former is retained in the latter to fix the profile 1 and the channel 120. This may allow to connect the blind T and the roller 110.

The channel 120 may be retained in the roller 110 so as to avoid the inadvertent disinsertion, for example disinsertion during use, that is when winding/unwinding the roller, or during the system assembly steps.

On the other hand, as better explained hereinafter, the portion 20 may be removably inserted into the channel 120 so as to selectively allow the operator to axially or radially disinsert the profile 1 from the channel 120 and therefore from the roller tube 110, for example in case of maintenance.

The shaped portion 20 may have a pair of opposite ends 21, 25. Suitably, once the portion 20 is inserted into the channel 120, the ends 21, 25 may remain on opposite sides with respect to the median plane n.

As better described below, the profile 1 may have different configurations. In particular, the portion 20 may have a substantially U-shaped cross-section, as schematically shown in FIG. 3 and in FIG. 7A, or it may have a substantially V-shaped or anchor-shaped cross-section, as schematically shown in FIG. 6A, or it may have a substantially O-shaped, that is circular ring-shaped, cross-section, as schematically shown in FIG. 8A and in FIG. 9A.

Suitably, irrespective of the configuration of the portion 20, the profile 1 may be movable between a narrowed configuration so as to allow the insertion/disinsertion of the portion 20 into/from the channel 120 and an expanded configuration so as to prevent at least the disinsertion of the portion 20 from the channel 120.

When the profile is in the narrowed configuration, the ends 21, 25 may be in a mutually proximal position in which they allow the insertion/disinsertion of the portion 20 into/from the channel 120, while when the profile is in expanded configuration the ends 21, 25 may be in a mutually distal position in which they allow at least the disinsertion of the portion 20 from the channel 120.

In greater detail, the edges 122 and 123 of the channel 120 may have a predetermined distance d1. Suitably, the ends 21, 25—in mutually proximal position—may have a mutual distance d2 parallel to the direction of the distance d1 which may be substantially equal to or smaller than the distance d1 and—in mutually distal position—may have a distance d2 mutually parallel to the direction of the distance d1 which may be greater than the distance d1.

Advantageously, the end 21 and the opposite end 25 may be elastically forced against the inner surface 121 of the channel 120 to cooperate with the latter so as to avoid the disinsertion of the portion 20 from the channel 120. For example, once the portion 20 has been inserted into the channel 120, the distance d2 of the ends 21, 25 in distal position may be smaller than the distance that the ends 21, 25 would have outside the channel 120 without constraints.

Suitably, all or at least part of the portion 20 may be elastically deformable and/or there may be provided for a portion 30 interposed between the portion 10 and the portion 20 to promote such elastic action for forcing the ends 21 and 25 against the inner surface 121.

The elastically deformable portion, that is the entire or part of the portion 20 and/or the portion 30, may be made of a deformable material, preferably made of elastically deformable material. For example, such deformable material may be an elastomeric material.

Such elastomeric material may have a hardness comprised between 100 shore A and 40 shore D, preferably, a Shore A hardness measured in accordance with the ISO 868 standard comprised between 75 Sh A and 95 Sh A. Preferably, such material may be a thermoplastic elastomer.

Advantageously, the deformability of the portion 20 and/or of the portion 30 may be particularly high so as to elastically force the ends 21, 25 against the inner surface 121 of the channel 120 even when the latter has large dimensions.

Furthermore, thanks to the elastic forcing, the same profile 1 may be used with channels 120 of different dimensions.

Suitably, should the portion 30 be present, the deformation of the latter may allow the profile 1 to pass between the expanded configuration and the retracted configuration. Suitably, the deformation of the portion 30 may allow the ends 21, 25 to pass between the proximal and distal positions.

According to a preferred but not exclusive embodiment, the portion 10 and/or the portion 20 may be made of the same material as the portion 30, that is the portion 30 may include the portion 20 or the portion 10, or the portion 20 and the portion 10.

Preferably, the profile 1 may be entirely made of such elastomeric material described above for the portion 30, for example as shown in FIG. 4C.

In this case, one or more parts of the portion 20 may be deformed so as to allow the profile 1 to pass between the expanded configuration and the retracted configuration. Suitably, the deformation of one or more parts of the portion 20 may therefore allow the ends 21, 25 to pass between the proximal and distal positions.

Advantageously, the deformability of the portion 20 and/or of the portion 30 may be particularly high so as to allow insertion into channels 120 in which the distance d1 is particularly small.

On the other hand, according to a different embodiment, the portion 20 and/or the portion 10 may be at least partially made of a material having a greater rigidity than the elastomeric material of the portion 30. For example, as schematically shown in FIG. 4D, the support portion 10 may be made of rigid polymeric material, while the remaining portion 20 may be made of elastomeric material.

Also in this case, one or more parts of the portion 20 may be deformed so as to allow the profile to pass between the expanded configuration and the retracted configuration.

The rigid material may be a material having a greater rigidness than the material of the portion 30. Such material may be a plastomer, a thermoplastic elastomer, or a metal material, for example aluminium.

Advantageously, in case of different materials, the profile 1 may be obtained through coextrusion.

With reference to the attached figures, described below are some preferred but non-exclusive embodiments of the invention.

According to a first embodiment FIG. 3-FIG. 5D, the end 21 may comprise a longitudinal relief 22 having an operative surface 22′ designed to come into contact with the area 121′ of the inner surface 121 of the channel 120 in proximity of the edge 122.

Such relief 22 may avoid the radial sliding of the portion 20 and therefore, advantageously, this may allow to prevent the removal of the portion 20 from the channel 120, that is the disinsertion of the portion 20 from the channel 120.

On the other hand, the end 25 may comprise an operative face 26 with an operative surface 26′ designed to come into contact with the area 121″ of the inner surface 121 of the channel 120 in proximity of the edge 123. In this manner, advantageously, the rotation of the profile 1 around the axis Y and/or X may be avoided.

In particular, such rotation promoted by the winding/unwinding action of the blind T may be avoided.

For example, with reference to FIG. 3, thanks to the mutual interaction of the operative surface 26′ and of the area 121″, once the portion 20 has been inserted into the channel 120, the rotation in the anticlockwise direction with respect to the axis Y or to an axis parallel thereto may be avoided. In particular, the rotation in the anticlockwise direction with respect to an axis passing through the edge 122 may be avoided.

Advantageously, at least one part of the portion 20 may be elastically deformable so that the relief 22 and the operative face 26 are elastically forced against the inner surface 121 of the channel 120 to cooperate so as to avoid the disinsertion of the portion 20 from the channel 120.

Preferably, the portion 20 may be snap-inserted into the channel 120.

In particular, the relief 22 and the operative face 26 of the ends 21 and 25 and they may be movable between a mutually proximal configuration in which they allow the insertion/disinsertion of the portion 20 into/from the channel 120 and the mutually distal configuration in which they do not allow the insertion/disinsertion of the portion 20 into/from the channel 120.

In particular, the edges 122 and 123 of the channel 120 may have a predetermined distance d1, while the operative surface 22′ and 26′ of the ends 21 and 25 in distal position inside the channel 120 may have a distance d2 substantially greater than the distance d1.

In this manner, advantageously, the disinsertion may be avoided and/or the operative surface 22′ and 26′ may be elastically forced against the inner surface 121.

In any case, the elastic deformability of the second portion 20, or of a part thereof, may be such that the relief 22 and the operative face 26 in the proximal position have a mutual distance substantially smaller than the distance d1 so as to allow the insertion of the portion 20 in the channel 120.

According to a particular aspect of the invention, the relief 22 and the support portion 10 may cooperate to define a seat 12 for the insertion of the edge 122 of the channel 120. In this manner, advantageously, the profile 1 may adhere to the channel 120 at the edge 122.

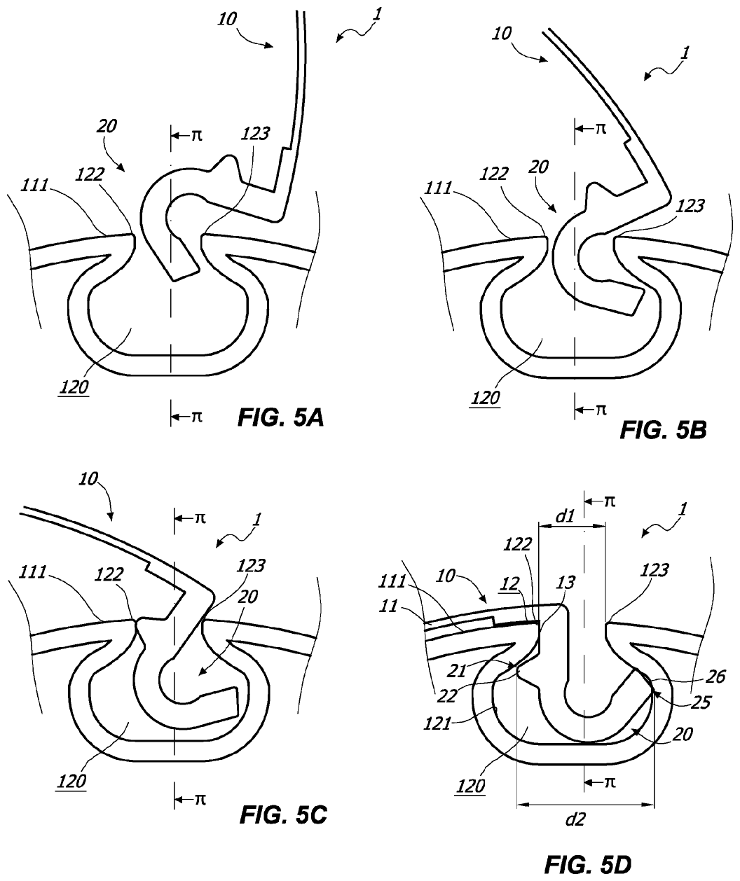

In greater detail, the action of the blind T-when winding/unwinding-promotes the approaching of the profile 1 toward the edge 122, that is the rotation in the anticlockwise direction around the edge 122 described above. Advantageously, the area 13 of the profile 1 which comprises the seat 12 may adhere to the edge 122 so as to counteract such rotation action promoted with the blind T preventing the profile 1 from rotating inside the channel 120, for example in the anticlockwise direction with reference to FIG. 5D.

Preferably, in such embodiment the entire portion 20 may be elastically deformable so as to allow the insertion/disinsertion thereof into/from the channel 120 and promote the elastic forcing of the ends 21, 25 against the surface 121.

However, it is clear that such embodiment is not exclusive. As a matter of fact, the portion 20 may comprise only one elastically deformable area, for example the U or V-shaped central area of the portion 20, while the remaining areas of the portion 20 may be substantially rigid.

Possibly, for example as shown in FIGS. 4A and 4B, the portion 20 may include or consist of a plurality of substantially V-shaped or U-shaped elements 27. The latter may be interspaced by an interspace 28 with predetermined length. Preferably, the elements 27 may be equal to each other, or even more preferably, they may be interspaced with interspaces 28 with length equal to each other.

Such elements 27 may be made of the substantially rigid material described above, for example it may be metallic or polymeric.

For example, the profile 1 may comprise the relief 22 made of elastomeric material and the operative face 25 made of rigid material (FIG. 4A), so that the former may be deformable and easily inserted into the channel 120.

On the other hand, as schematically shown in FIG. 4B, the portion 20 may be configured so that the both the relief 22 and the operative face 25 are made of substantially rigid material so that the sealing of the profile 1 is particularly high and there is a snap upon insertion.

Suitably, as schematically illustrated in FIGS. 5A to 5D, the profile 1 described above may be inserted/disinserted by rotating around the edge 123. For example, with reference to such figures, it may be inserted with an anticlockwise rotation and disinserted with a clockwise rotation.

In other words, the rotation of the profile 1 may allow the ends 21, 25 to pass from the extended configuration to the narrowed configuration and vice versa so as to allow the insertion/disinsertion of the portion 20 into/from the seat 20.

In this manner, the insertion and the disinsertion of the portion 20 may be particularly quick. Suitably, the relief 22 may allow the snap-coupling.

According to a particular embodiment shown in FIG. 7A and in FIG. 7B, the channel 120 may have a particular shape, while the portion 20 may have a corresponding counter-shape so that once the latter is inserted into the former, they remain coupled by shape coupling. The entire outer surface of the portion 20 may therefore be in contact with the surface 121 of the channel 120. Suitably, both the channel 120 and the portion 20 may be generally arc-shaped so as to facilitate the insertion of the former into the latter by rotation e and simultaneously avoid the exit thereof from the channel 120 due to the action of the blind T.

In other words, such embodiments of the substantially arc-shaped portion 20 which can be inserted into the channel 120 by rotation are one-directional, that is once they have been inserted into the channel 120, they allow to fix the blind only on one side, and the corresponding winding of the roller (for example the winding in the clockwise direction with reference to FIG. 5D).

On the other hand, according to a different embodiment for example shown in FIG. 6A-6D, the portion 20 may be substantially anchor-shaped and it may be substantially symmetrical with respect to the plane n.

Thanks to this characteristic, the profile 1 may be fixed to the 120 regardless of the winding of the blind T, that is regardless of the fact that the blind T is wound on the roller 110 in the clockwise or anticlockwise direction.

In particular, the portion 20 may comprise a pair of opposite ends 21, 25 which may comprise opposite operative surfaces 22′, 26′ with respect to the median plane n. Once inside the channel 120, the opposite surfaces 22′, 26′ may abut against or they may be forced to abut against the surface 121 of the channel 120 in a manner similar to the relief 22 and to the operative face 26 described above.

The portion 20 may further comprise a further pair 13, 14 of opposite operative faces with respect to the median plane n. Such faces 13, 14 may come into contact respectively with the edge 122 and 123 so as to act as a “centring” for the profile 1. Furthermore, advantageously, the operative faces 13 and 14 may cooperate with the opposite operative surface 26′ and 22′ for preventing the rotation of the profile 1 in the channel 120 respectively in an anticlockwise or clockwise direction, with reference to FIG. 6C.

Preferably, the opposite faces or areas 13, 14 may be on opposite side with respect to the area 18. In particular, the area 18 may be a concave area between the opposite faces or areas 13, 14.

The portion 20 may therefore be deformable so as to allow the insertion of the portion 20 into the channel 120, preferably snap-inserted, and to avoid the disinsertion of the portion 20 from the channel 120.

The ends 21, 25 in extended configuration (FIG. 6A and FIG. 6C) may have a distance d2 greater than the distance d1, while in the narrowed configuration (FIG. 6B) they may have a distance d2 substantially equal to the distance d1 so as to allow the insertion of the portion 20 into the channel 120.

It is clear that in such embodiments the profile 1 may be entirely made of rigid material, for example metal or polypropylene, or entirely made of elastically deformable material, or it may comprise one or more portions 30 made of deformable material, for example the base of the V-shaped element of the portion 20, and one or more relatively rigid areas, for example the ends 21, 25.

Advantageously, thanks to such embodiment, the portion 20 may be inserted into the channel 120 when the roller is accessible from the bottom, that is the insertion of the portion 20 into the channel 120 occurs from the bottom upwards and when the roller is accessible laterally, that is the insertion of the portion 20 in the channel 120 occurs laterally, from the right or from the left.

As a matter of fact, once the portion 20 has been inserted into the channel 120, the ends 21, 25 may be elastically deformed in the extended configuration so as to prevent the disinsertion of the portion 20.

In this manner, the profile 1 is particularly versatile and it allows an easy assembly operation.

According to a particular embodiment shown in FIG. 8B and in FIG. 9B, the portion 20 may be entirely made of deformable elastomeric material. Preferably, in such embodiment, the entire profile 1 may be made of elastomeric material.

Suitably, the portion 20 may comprise an internal chamber 41 for a working fluid, for example air. Such internal chamber 41 may be a variable volume, that is it may pass between at least one expanded configuration with maximum volume and at least one narrowed configuration with minimum volume.

In particular, when the chamber 41 has a minimum volume, the tubular portion 20 is in narrowed configuration and it may be inserted/disinserted into/from the channel 120 (FIG. 8A and FIG. 9A), while when the chamber 41 has maximum volume the tubular portion 20 is in expanded configuration and this may allow to avoid the insertion/disinsertion of the portion 20 into/from the channel 120 (FIG. 8B and FIG. 9B).

In greater detail, when the working chamber 41 is narrowed, the portion 20 may have a pair of opposite surfaces 22′, 26′ whose distance d2 is substantially equal to or smaller than the distance d1 between the edges 122, 123 (FIG. 8A and FIG. 9A), while when the working chamber 41 is expanded, the portion 20 may have a pair of opposite surfaces 22′, 26′ whose distance d2 is substantially greater than the distance d1 between the edges 122, 123 (FIG. 9).

Suitably, the ends 21, 25 may comprise the opposite surfaces 22′, 26′. In this manner, in the narrowed configuration of the portion 20, the ends 21, 25 may have the distance d2 substantially equal to or smaller than the distance d1 while in the expanded configuration of the portion 20 the ends 21, 25 may have the distance d2 substantially greater than the distance d1. In other words, the expanded and narrowed configuration of the portion 20 may correspond to the expanded and narrowed configuration of the profile 1.

In greater detail, in expanded configuration, the surfaces 22′, 26′ may come into contact with the respective inner surfaces 121′, 121″ so as to avoid the disinsertion of the profile 1 from the channel 120.

In this manner, advantageously, once the portion 20 has been inserted into the channel 120, and once the working chamber 41 has been closed so that air does not exit therefrom to keep the former in expanded configuration, the disinsertion of the portion 20 from the channel 120 may be avoided.

Suitably, the tubular portion 20 may comprise at least one opening 42 so as to allow the inflow/outflow of air F into/from the working chamber 41.

In particular, such opening 42 may be selectively openable/closable so that when it is open it allows the air to flow out from the chamber 41 so as to allow the insertion of the portion 20 into the channel 120, and when it is closed it prevents air F from flowing out from the chamber 41 so as avoid the disinsertion of the portion 20 from the chamber 120.

Advantageously, the opening 42 may be selectively openable/closable through closing means 43, for example a plug 43, which can be actuated by the operator.

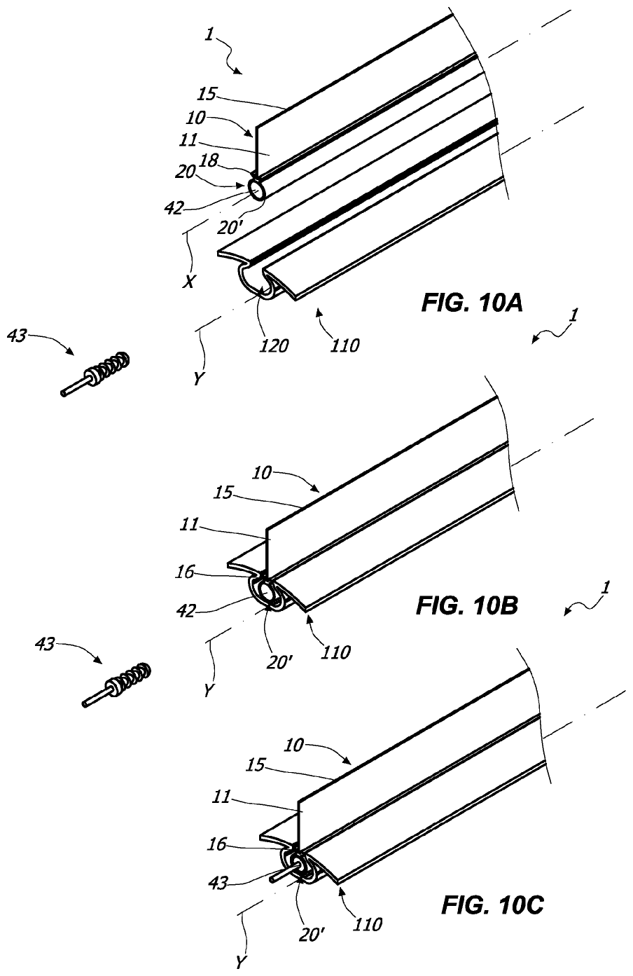

For example, as shown in FIG. 10A, the portion 20 may be substantially tubular-shaped with a length along the axis X substantially equal to the length of the channel 120 along the axis Y so that the tubular portion 20 has at least one end 20′ accessible from the external. The opening 42 may therefore be at such end 20′.

Preferably, the tubular portion 20 may comprise a pair of opposite ends 20′ both of which may be accessible from the external and each may comprise an opening 42. Preferably, each of these may be suitable to be closed with the plug 43.

Therefore, the operator may operatively open the openings 42 (FIG. 10A), for example by unscrewing or removing the plugs 43 arranged at the end 20′ and insert the portion 20 into the channel 120 so that the former is elastically deformed upon the insertion and it has a width d2 substantially equal to the distance d1 between the edges 122, 123.

Once the portion 20 has been inserted into the channel 120, the former will be elastically deformed so as to return to the expanded configuration in which the distance d2 is greater than the distance d1 of the edges 122, 123 (FIG. 10B), and the openings 42 may be closed, for example by screwing or by inserting one or more plugs 43 at the end 20′ or at both opposite ends 20′ (FIG. 10C).

This will allow to prevent the chamber 41 from passing from the expanded configuration to the narrowed configuration and therefore this may allow to avoid the inadvertent disinsertion of the portion 20 from the channel 120.

The configuration of the profile 1 described above with the chamber 41 may allow the insertion/disinsertion of the portion into/from the channel 120 simply and quickly.

The embodiment of the profile 1 of FIG. 8A-8B and that of FIG. 9A-9B essentially differ respectively due to the absence and the presence of the areas 13, 14 having the centring and/anti-rotation functions described above. In particular, even in the embodiment of FIG. 9A-9B, the areas 13, 14 cooperate with the surfaces 22′ and 26′ as described above so as to avoid the rotation of the profile 1.

Advantageously, the embodiment of FIG. 8B may therefore be easy to obtain and it may be cost-effective while maintaining part of the functions. As a matter of fact, such embodiment may allow the rotation of the profile 1 in the channel 120 around the axis X, but it may equally prevent the disinsertion of the former from the latter.

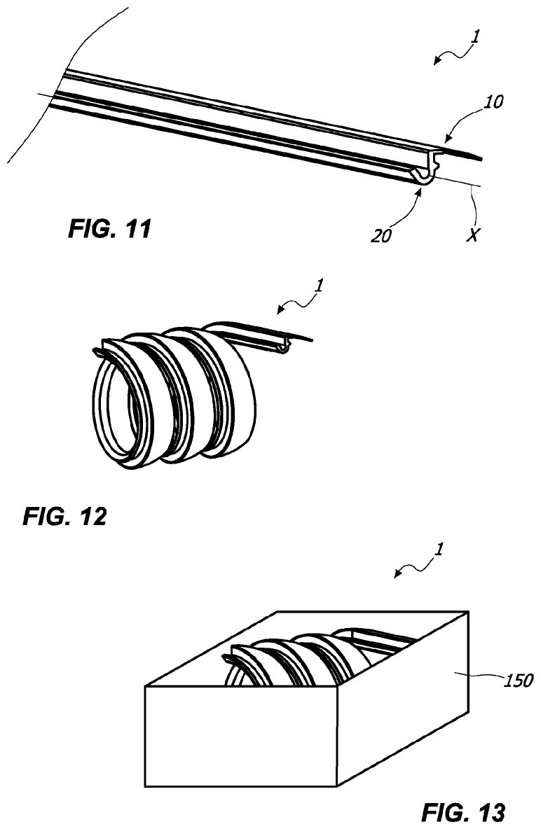

Regardless of the configurations described above, and in particular regardless of the configuration of the portion 20, the profile 1 may be movable between a working configuration extended along the axis X (FIG. 11) and a collapsed configuration (FIG. 12), that is a deformation along a plane substantially parallel to the axis X.

It is clear that such deformation may possibly allow a slight torsion of the profile 1, that is a torsion with respect to the axis X.

In this manner, when the profile 1 is in the collapsed condition, it may have particularly small overall dimensions with reference to the length-wise extension thereof, that is it may have overall dimensions much smaller than the ones it has in the extended working configuration.

Thanks to this characteristic, the transportation and storage of the profile 1 or of a plurality of profiles 1 may be simple and cost-effective. For example, as schematically shown in FIG. 12, the profile 1 may be spiral-wound. It is clear that such collapsed configuration, or transportation and/or storage configuration, may be different depending on the needs without departing from the scope of protection of the attached claims.

Advantageously, the profile 1 in collapsed configuration may be easily transported in a container 150 with small overall dimensions and easy to operate.

Suitably, the profile may comprise a portion 30 interposed between the portion 10 and the portion 20 for mutually connecting the latter.

Such portion 30 may be configured so as to allow the configuration variation of the profile between the extended configuration and the collapsed configuration. In particular, to this end, the portion 30 may be deformable, preferably it may be elastically deformable. This may allow to easily move the profile 1 between the collapsed configuration and the extended configuration.

The expression elastically deformable material is used to indicate that the deformable material may be sufficiently deformable so as to allow the aforementioned configuration variation between the extended configuration and the collapsed configuration.

Preferably, the portion 30 may be made of the elastomeric material described above. For example, such elastomeric material may have a hardness comprised between 100 shore A and 40 shore D, preferably, a Shore A hardness measured in accordance with the ISO 868 standard comprised between 75 Sh A and 95 Sh A. Preferably, such material may be a thermoplastic elastomer.

Suitably, the deformable portion 30 may be interposed between the portion 10 and the portion 20, and/or it may include the portion 10.

For example, as described above with reference to the embodiment of FIGS. 4A and 4B, the profile 1 may comprise the portion 30 made of deformable material and a plurality of rigid elements 27 interspaced by interspaces 28 so as to allow the profile to pass from the extended to the collapsed configuration. In this case, advantageously, passing from the extended to the collapsed configuration even in the presence of rigid elements 27 may be allowed.

In greater detail, the relief 22 and the operative face 26 may pass between a mutually proximal and a distal configuration so as to allow a deformation along a plane substantially perpendicular to the axis X so as to allow the insertion of the portion 20 into the channel 120. While the rigid elements 27 may approach and bend with respect to each other thanks to the presence of interspaces 28 so as to allow the collapsing of the profile.

Suitably, in this case, the portion 30 may allow the profile 1 to pass from the extended configuration to the collapsed configuration and simultaneously it may allow the profile to pass between the retracted configuration and the expanded configuration.

On the other hand, it is clear that should the portion 20 and/or the portion 10 be made of such deformable material, it may include the portion 30 made of such deformable material.

For example, for example as shown in FIG. 4C, the entire profile 1 may be made of deformable material, that is the entire profile 1 may be elastically deformable. In this manner, advantageously, the profile 1 may be continuous along the axis X. Furthermore, it may be particularly simple and cost-effective to obtain.

It is clear that what has been described above with reference to the embodiment of FIG. 4C, may be equally valid with different embodiments of the profile 1 and in particular with different shapes of the portion 20. For example, the profile 1 according to one or more of the embodiments shown from FIG. 5A to FIG. 5B, from FIG. 6A to FIG. 6D, from FIG. 7A to FIG. 7B, and from FIG. 8A to FIG. 9B may be entirely made of deformable material.

Regardless of the embodiments of the profile 1 described above, and in particular regardless of the embodiment of the portion 20, there may be provided for a kit for transporting a profile or a plurality of profiles 1 which may comprise at least one container 150 and one or more profiles 1 inserted into the container 150 in a narrowed transportation configuration, that is in the collapsed configuration described above.

Suitably, in order to allow an easy positioning of one or more profiles 1 in the container 150, the profiles 1 may comprise the deformable portion 30, or they may be entirely made of elastically deformable material, so as to allow the profile 1 to pass from the extended position to the collapsed position and vice versa.

For example, as schematically shown in FIG. 13, the profiles 1 in collapsed configuration may be rolled into a helical shape, or they may be wound on reels.

According to a particular aspect of the invention, there may be provided for a system 100 for anchoring the blind T to the support structure S. Suitably, the system 1 may comprise the roller tube 110 and a fastening bar 180.

Preferably, the blind T may be installed at an opening A. In this case, the roller tube 110 and the fastening bar 180 may be on opposite sides with respect to the opening A, for example a window, French door, or the like.

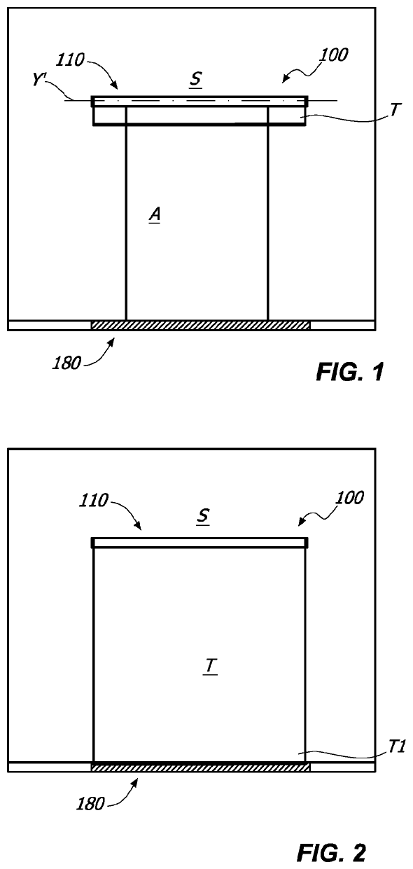

The blind T may be movable between an extended position (FIG. 2) in which it covers the opening A and a narrowed position (FIG. 1) in which the opening A is at least partially open.

The system 100 may therefore comprise the roller 110 and the fastening bar 180 each of which may comprise a respective longitudinal channel 120.

The system 100 may therefore comprise at least one longitudinal connection profile 1 having the portion 10 fixed to an end T1 of the blind T and the portion 20 can be inserted into the channel 120 of the roller tube 110, and at least one second connection profile 1 with the respective portion 10 fixed to the other end of the blind T and the respective portion 20 which can be removably inserted into the channel 120 of the fastening bar 180 so as to removably lock the blind T in the extended position.

The connection profiles 1 with the roller 110, for example the upper profile, and the connection profile 1 with the fastening bar 180, for example the lower profile, may be obtained according to one or more of the embodiments described above.

Preferably, the connection profile 1 with the fastening bar 180 may be easy to connect/disconnect with the fastening bar 180. For example, such profile 1 may preferably but not exclusively be made according to the embodiment of FIG. 3 described above so that—through a simple rotation around the axis X of the portion 20 (FIG. 5A-FIG. 5D), the user may disinsert the portion 20 from the channel 120 and therefore allow the blind T to pass from the extended configuration to the narrowed configuration.

With reference to the figures FIG. 5A-FIG. 5D, such rotation for disinserting the portion 20 from the channel 120 may be carried out in the clockwise direction.

The invention is susceptible to numerous modifications and variants all falling within the inventive concept outlined in the attached claims. All details can be replaced by other technically equivalent elements, and the materials can be different depending on the needs, without departing from the scope of protection of the invention.

Even though the invention has been described with particular reference to the attached figures, the reference numbers utilised in the description and in the claims are meant for improving the intelligibility of the invention and thus do not limit the claimed scope of protection in any manner whatsoever.

The invention claimed is:

1.-30. (canceled)

31. A longitudinal profile usable in a roller blind system to connect a blind to a roller tube or a fastening bar that comprises a longitudinal channel defining a first axis, the longitudinal profile having an elongated shape that defines a second axis, the longitudinal profile comprising:
a first longitudinal portion for connection to one end of the roller blind;
a second longitudinal portion configured to be received into the longitudinal channel so that the first and the second axis are parallel to, or coincident with, one another; and
a third portion interposed between the first portion and the second portion for a mutual connection thereof,
wherein the third portion is made of a first elastomeric material so as to enable a configuration variation of the longitudinal profile between a working configuration extended along the first axis and a collapsed transportation configuration having longitudinal dimensions smaller than the longitudinal dimensions in the working configuration.

32. The longitudinal profile according to claim 31, wherein when the longitudinal profile in the collapsed configuration it is helical or spiral-shaped.

33. The longitudinal profile according to claim 31, wherein the first elastomeric material has a Shore A hardness measured in accordance with the ISO 868 standard comprised between 75 Sh A and 95 Sh A.

34. The longitudinal profile according to claim 31, wherein the first elastomeric material is a thermoplastic elastomeric material.

35. The longitudinal profile according to claim 31, wherein the first portion and the second portion are made of a second and respectively a third elastomeric material, the first, the second and the third elastomeric materials being the same elastomeric material.

36. The longitudinal profile according to claim 31, wherein the second portion comprises a plurality of V-shaped or U-shaped elements made of a fourth material having a greater rigidity than the first elastomeric material, the plurality of V-shaped or U-shaped elements being interspaced by an interspace of a predetermined length so as to allow the configuration variation of the longitudinal profile between the working configuration and the collapsed transportation configuration.

37. The longitudinal profile according to claim 31, wherein the second portion can be removably inserted into the longitudinal channel.

38. The longitudinal profile according to claim 31, wherein the longitudinal channel has an inner surface with first and second end edges arranged on opposite sides of a median plane passing through the first axis, the first and the second end edges having a first predetermined distance therebetween, the second portion having a first and a second opposite end, and wherein, after the second portion is inserted into the longitudinal channel, the first and second end of the second portion being arranged on opposite sides with respect to the median plane and having a second distance therebetween that is larger than the first distance so as to prevent a disinsertion of the second portion from the longitudinal channel.

39. The longitudinal profile according to claim 38, wherein the first end of the second portion has a first operative surface configured to come into contact with the inner surface of the longitudinal channel at one of the first or the second end edge, the second opposite end of the second portion having a second operative surface configured to come into contact with the inner surface of the longitudinal channel at the other one of the first or the second end edge so as to prevent the disinsertion of the second portion from the longitudinal channel.

40. The longitudinal profile according to claim 38, wherein at least one part of the second portion is elastically deformable so that after the second portion is inserted into the longitudinal channel, the first end and the second opposite end are elastically forced against the inner surface of the longitudinal channel to cooperate therewith so as to avoid the disinsertion of the second portion from the longitudinal channel.

41. The longitudinal profile according to claim 38, wherein the second portion is configured to be inserted into the longitudinal channel by a radial transaction along a direction parallel to, or lying in, the median plane.

42. The longitudinal profile according to claim 38, wherein the second portion is configured to be inserted into the longitudinal channel by rotating around one of the first or the second end edge.

43. The longitudinal profile according to claim 31, wherein the second portion has a concave coupling area, the first portion including a planar element with an end area coupled to the coupling area, the end area being deformable to enable a passage of the planar element between an inoperative configuration, in which the planar element extends in a plane perpendicular to the coupling area so that after the second portion has been inserted into the longitudinal channel, the planar element extends radially to the roller, and an operative configuration, in which the planar extends in a plane parallel to the coupling area so that after the second portion has been inserted into the longitudinal channel, the planar element extends tangentially to the roller so as to enable a winding of the blind.

44. A transportation kit comprising:
a container; and
a plurality of longitudinal profiles according to claim 31, the plurality of longitudinal profiles being inserted into the container in the collapsed transportation configuration.

45. A system for anchoring a blind to a support structure at an opening thereof, the blind being movable between an extended position in which the blind covers the opening and a shortened position, the system comprising:
a roller tube and a longitudinal fastening bar configured to be installed at the support structure, on opposite sides with respect to the opening, the roller tube and the fastening bar each comprising a longitudinal channel;
a first longitudinal profile according to claim 31 having the first portion fixed at one end of the blind and the second portion configured to be inserted into the longitudinal channel of the roller tube; and
a second longitudinal profile according to claim 31 having the first portion fixed to the other end of the blind and the second portion configured to be removably inserted into the longitudinal channel of the longitudinal fastening bar so as to removably lock the blind in the extended position.
